(19) United States
(12) Patent Application Publication
(10) Pub. No.: US 2022/0040973 A1
(43) Pub. Date: Feb. 10, 2022

(54) TEMPERATURE MONITORING OF FLUIDIC DIE ZONES

(71) Applicant: Hewlett-Packard Development Company, L.P., Spring, TX (US)

(72) Inventors: Daryl E Anderson, Corvallis, OR (US); Eric Martin, Corvallis, OR (US)

(73) Assignee: Hewlett-Packard Development Company, L.P., Spring, TX (US)

(21) Appl. No.: 17/297,754

(22) PCT Filed: Apr. 30, 2019
(86) PCT No.: PCT/US2019/030063

§ 371 Date: May 27, 2021

(51) Int. Cl. B41J 2/045

(52) U.S. Cl. CPC B41J 2/04563; B41J 2/04586

(57) ABSTRACT

A temperature monitoring circuit for a fluidic die, the temperature monitoring circuit including input logic to receive a series of zone temperature values, each zone temperature value corresponding to a different zone of the fluidic die, and evaluation logic. For each zone temperature value, the evaluation logic to replace a current minimum temperature value with the zone temperature value if the zone temperature value is less than the current minimum temperature value, and to replace a current maximum temperature value with the zone temperature value if the zone temperature value is greater than the current maximum temperature value.

### BACKGROUND

Some print components may include an array of nozzles and/or pumps each including a fluid chamber and a fluid actuator, where the fluid actuator may be actuated to cause displacement of fluid within the chamber. Some example fluidic dies may be printheads, where the fluid may correspond to ink or print agents. Print components include printheads for 2D and 3D printing systems and/or other high-pressure fluid dispensing systems.

### BRIEF DESCRIPTION OF THE DRAWINGS

FIG. 1 is a block and schematic diagram generally illustrating a temperature monitoring circuit for a fluidic die, according to one example.

FIG. 2 is a block and schematic diagram generally illustrating a fluidic die employing a temperature monitoring circuit, according to one example.

FIG. 3 is a block and schematic diagram generally illustrating a temperature monitoring circuit, according to one example.

FIG. 4 is a flow diagram illustrating a method of adjusting a pulse width for a fluidic die, according to one example.

FIG. 5 is a flow diagram describing a method of controlling a fire pulse for a fluidic die, according to one example.

FIG. 6 is a schematic diagram illustrating a block diagram illustrating one example of a fluid ejection system.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Examples of print components, such as fluidic dies, for instance, may include fluid actuators. The fluid actuators may include thermal resistor-based actuators (e.g., for firing or recirculating fluid), piezoelectric membrane based actuators, electrostatic membrane actuators, mechanical/impact driven membrane actuators, magneto-strictive drive actuators, or other suitable devices that may cause displacement of fluid in response to electrical actuation. Fluidic dies described herein may include a plurality of fluid actuators, which may be referred to as an array of fluid actuators. An actuation event may refer to singular or concurrent actuation of fluid actuators of the fluidic die to cause fluid displacement. An example of an actuation event is a fluid firing event whereby fluid is jetted through a nozzle orifice.

Example fluidic dies may include fluid chambers, orifices, fluidic channels, and/or other features which may be defined by surfaces fabricated in a substrate of the fluidic die by etching, microfabrication (e.g., photolithography), micromachining processes, or other suitable processes or combinations thereof. In some examples, fluidic channels may be microfluidic channels where, as used herein, a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). Some example substrates may include silicon-based substrates, glass-based substrates, gallium arsenide-based substrates, and/or other such suitable types of substrates for microfabricated devices and structures.

In example fluidic dies, a fluid actuator (e.g., a thermal resistor) may be implemented as part of a fluidic actuating structure, where such fluidic actuating structures include nozzle structures (sometimes referred to simply as “nozzles”) and pump structures (sometimes referred to simply as “pumps”). When implemented as part of a nozzle structure, in addition to the fluid actuator, the nozzle structure includes a fluid chamber to hold fluid, and a nozzle orifice in fluidic communication with the fluid chamber. The fluid actuator is positioned relative to the fluid chamber such that actuation (e.g., firing) of the fluid actuator causes displacement of fluid within the fluid chamber which may cause ejection of a fluid drop from the fluid chamber via the nozzle orifice. In one example nozzle, the fluid actuator comprises a thermal actuator, where actuation of the fluid actuator (sometimes referred to as “firing”) heats fluid within the corresponding fluid chamber to form a gaseous drive bubble that may cause a fluid drop to be ejected from the nozzle orifice.

When implemented as part of a pump structure, in addition to the fluid actuator, the pump structure includes a fluidic channel. The fluid actuator is positioned relative to a fluidic channel such that actuation of the fluid actuator generates fluid displacement in the fluid channel (e.g., a microfluidic channel) to thereby convey fluid within the fluidic die, such as between a fluid supply and a nozzle structure, for instance.

As described above, fluid actuators, and thus, the corresponding fluidic actuator structures, may be arranged in arrays (e.g., columns), where selective operation of fluid actuators of nozzle structures may cause ejection of fluid drops, and selective operation of fluid actuators of pump structures may cause conveyance of fluid within the fluidic die. In some examples, the array of fluidic actuating structures may be arranged in sets of fluidic actuating structures, where each such set of fluidic actuating structures may be referred to as a “primitive” or a “firing primitive.” The number of fluidic actuating structures, and thus, the number of fluid actuators in a primitive, may be referred to as a size of the primitive.

In some examples, the set of fluidic actuating structures of each primitive are addressable using a same set of actuation addresses, with each fluidic actuating structure of a primitive and, thus, the corresponding fluid actuator, corresponding to a different actuation address of the set of actuation addresses. In examples, the address data representing the set of actuation addresses are communicated to each primitive via an address bus shared by each primitive. In some examples, in addition to the address bus, fire pulse lines communicate a number of fire pulse signals to each primitive, and each primitive receives actuation data (sometimes referred to as fire data, nozzle data, or primitive data) via a corresponding data line.

In some cases, electrical and fluidic operating constraints of a fluidic die may limit which fluid actuators of each primitive may be actuated concurrently for a given actuation event. Arranging the fluid actuators and, thus, the fluid actuating structures, into primitives facilitates addressing and subsequent actuation of subsets of fluid actuators that may be concurrently actuated for a given actuation event in order to conform to such operating constraints.

To illustrate by way of example, if a fluidic die comprises four primitives, with each primitive including eight fluid actuating structures (with each fluid actuator structure corresponding to different address of a set of addresses 0 to 7), and where electrical and/or fluidic constraints limit actuation to one fluid actuator per primitive, the fluid actuators of a total of four fluid actuating structures (one from each primitive) may be concurrently actuated for a given actuation event. For example, for a first actuation event, the respective fluid actuator of each primitive corresponding to address “0” may be actuated. For a second actuation event, the respective fluid actuator of each primitive corresponding to address “5” may be actuated. As will be appreciated, such example is provided merely for illustration purposes, with fluidic dies contemplated herein may comprise more or fewer fluid actuators per primitive and more or fewer primitives per die.

In some fluidic dies, fluidic actuating structures are arranged in columns, with the fluidic actuating structures of each column organized to form a series of primitives. In some examples, during an actuation or firing event, for each primitive, based on actuation data for the primitive communicated via its corresponding data line, the fluidic actuator corresponding to the address on the address bus will actuate (e.g., “fire”) in response to the fire pulse.

Heat generated during operation of the fluidic die may be absorbed by the substrate and other components. As a result, operating temperatures of regions of the die may be raised above a design operating temperature (e.g., 55° C.) and thermal gradients may form across the die. In some cases, localized thermal gradients of 15° C. or more may be formed. Such temperature increases and thermal gradients can adversely impact operation of the fluidic die.

For example, the relationship between fluid drop weight and fire pulse energy changes with temperature, where such variation of the operating temperature from the design temperature may affect ejection of fluid from nozzle structures. For instance, similar fluidic actuating structures at different operating temperatures may generate fluid drops having different weights in response to a same fire pulse. As a consequence, variations in operating temperature from a design temperature across a fluidic day may result in an undesirable variance is weight of ejected fluid drops.

For instance, when primitives of fluidic actuators are arranged in columns, thermal gradients tend to arise across a length of the columns, with operating temperatures increasing from the ends of the columns toward the middle. As a result, in response to a same fire pulse, fluidic actuating structures of primitives in middle portions of the columns may eject fluid drops of a greater drop weight than fluidic actuating structures of primitives nearer to the ends of the columns. It is noted that any number of different thermal gradients may arise across a column for any number of reasons, such as due to varying fluid ejection patterns, for example.

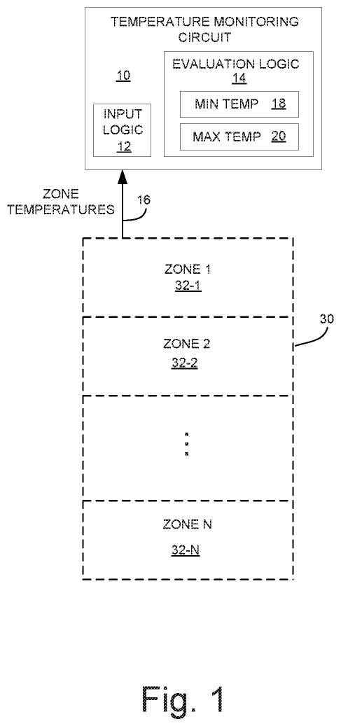

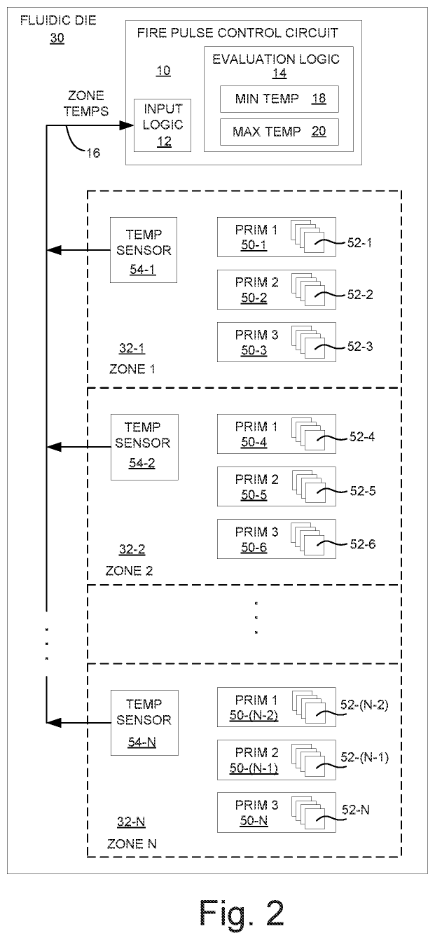

FIG. 1 is a block and schematic diagram generally illustrating a temperature monitoring circuit 10 for a fluidic die 30, according to one example of the present disclosure, which tracks minimum and maximum temperatures of defined thermal zones on the fluidic die. Tracking minimum and maximum temperatures may enable implementation of any number operating adjustments to improve fluidic die performance. For example, if temperatures exceed a specified limit, operation of the die may be slowed or halted, or if temperatures are below specified limit, additional heating may be provided to regions of the die. Although illustrated as being off fluidic die 30 in FIG. 1, in other examples, fire pulse control circuit 10 may be disposed on fluidic die 30 (e.g., see FIG. 2).

In one example, as illustrated, temperature monitoring circuit 10 includes input logic 12 and evaluation logic 14. Fluidic die 30 includes a number of zones, illustrated as zones 32-1 to 32-N. In one example, input logic 14 receives via a signal line 16 a series of zone temperatures, each zone temperature corresponding to different one of the zones 32 of fluidic die 30. In one example, the series of zone temperatures is in order from zone 32-1 to zone 32-N.

In one case, as each zone temperature value of the series of zone temperature values is received, evaluation logic 14 replaces a current minimum temperature value 18 with the current zone temperature value if the current zone temperature is less than the current minimum temperature value, and replaces a current maximum temperature value 20 with the current zone temperature value if the current zone temperature value is greater than the current maximum temperature value 20. In examples, current minimum and maximum temperature values 18 and 20 are stored in a memory element, such as a register, for example.

In one example, temperature monitoring circuit 10 repeats the above process for each received series of zone temperature values as described above, by tracking minimum and maximum zone temperatures over time for each series of zone temperature values, adjustments to the operation of the fluidic die 30 may be made to improve die performance.

FIG. 2 is a block and schematic diagram generally illustrating fluidic die 30 including temperature monitoring circuit 10, according to one example. As illustrated, each zone 32 includes a number of primitives 50, with each primitive 50 including a number of fluid actuating devices 52. For ease of illustration, while each zone 32 is illustrated as having three primitives 50 (e.g., zone 1 includes primitives 50-1 to 50-3, respectively including pluralities of fluid actuators 52-1 to 52-3), zones 32 may include any number of primitives 50.

Additionally, each zone 32 includes a thermal sensor 54 to provide a measured temperature of the corresponding zone 32. In one example, thermal sensor 54 is a thermal diode. In other examples, thermal sensor 54 may include any suitable temperature sensing device, such as thermal resistor, for instance.

During operation, temperature monitoring circuit 10, via input logic 12, periodically receives a series of zone temperature signals representative of zone temperatures from temperature sensors 54-1 to 54-N via signal path 16, with each zone temperature corresponding to a different zone 32. In one example, temperature monitoring circuit 10 receives a series of zone temperature signals from thermal sensors 54 every 500 microseconds, for instance. However, it is noted that any suitable interval may be employed, where such interval may be greater than or less than 500 microseconds.

In one example, the series of zone temperature values are received in the geographical order in which the zones are arranged on fluidic die 30 (e.g., zone 1 to zone N in FIG. 2). In one example, the series of zone temperature values are received in an order in which the zones 32 are fired during a firing operation. An order in which the series of zone temperature values are received may vary, so long as the series of zone temperature values includes a temperature value for each zone 32. In one case, zone temperatures from a subset of zones 32 may be monitored.

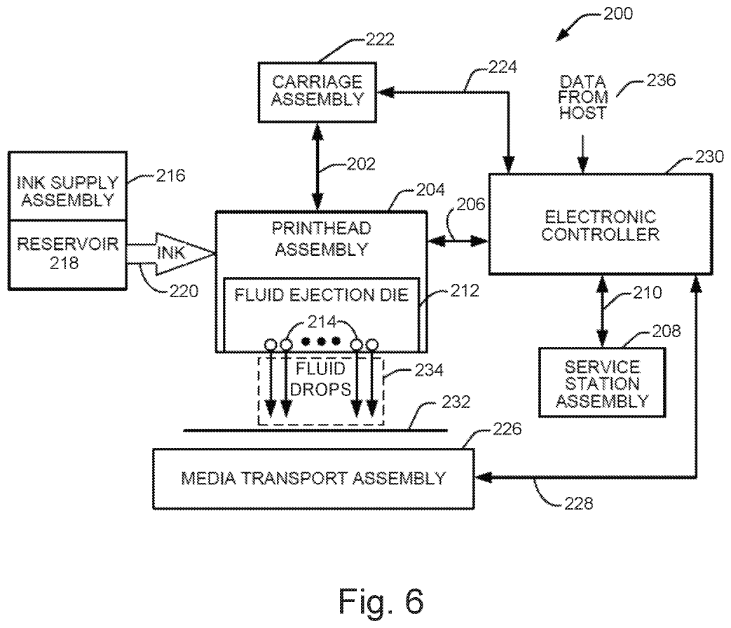

As described above, each time a series of zone temperatures is processed by temperature monitoring circuit 10, evaluation logic 14 determines a minimum temperature value 18 and a maximum temperature value 20 from the series of temperature values, where such minimum and maximum temperature values may be used for making decisions regarding operation of fluidic die 30. In one example, temperature monitoring circuit 10 may provide minimum and maximum temperature values 18 and 20 to a system controller (e.g., electronic controller 230 in FIG. 6) which may adjust operating parameters accordingly. In one example, the processing of zone temperature values by temperature monitoring circuit 10 may be performed asynchronously to firing operations of the fluid actuating devices 52 of primitives 50 of each zone 32.

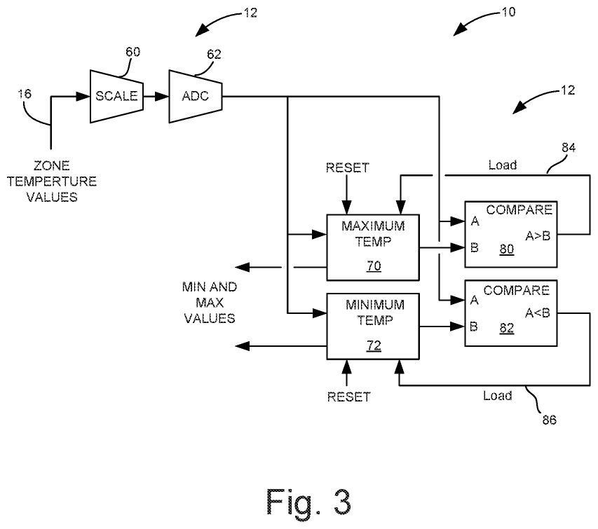

FIG. 3 is a block and schematic diagram generally illustrating fire pulse control circuit 10, including input logic 12 and evaluation logic 14, according to one example. In one example, input logic 12 includes a scaling block 60 and an analog-to digital converter (ADC) 62, with adjustment logic 14 including a first memory element 70 to store a maximum temperature value, a second memory 72 to store a minimum temperature value, a first comparator block 80, and a second comparator block 82. In one example, first and second memory elements 70 and 72 each comprise a register.

In one example, each time a series of zone temperature values received from temperature sensors 54 is to be evaluated by temperature monitoring circuit 10, first and second registers 70 and 72 are reset so as to hold an initial temperature value. In another example, first register 70 is reset with an initial value which is expected to be far less than an expected highest zone temperature value, such as a value of “0”, for instance. Similarly, second register 72 is reset with an initial value which is expected to be far greater than an expected lowest zone temperature. In one example, first register 70 is set with an initial value lower than a design operating temperature of the fluidic die (e.g., 50° C.), and second register 72 is set with an initial value higher than the design operating temperature, thereby ensuring that zone temperature values of the series of zone temperature values will exceed the value in first register 70 and be less values in second register 70. In another example, first and second registers 70 and 72 are set with initial values being a midpoint of zone temperature values expected to occur during operation.

In one example, scaling block 60 and ADC 62, together, receive and convert the series of analog zone temperature values received via signal line 16 from temperature sensors 54 to digital values representative of the zone temperature. For example, in one case, the analog values received from temperature sensors 54 are scaled and converted to integer values. This scaled and converted temperature value is sometimes referred to herein as a “synthetic” temperature (ST).

After scaling and conversion by scaling block 60 and ADC 62, each zone temperature value is successively provided to a first input (input “A”) of first and second comparator blocks 80 and 82, and provided at inputs to first and second registers 70 and 72, which respective hold the current high and low temperature values. The output of register 70, representing the current high temperature value, is provided at second input (input “B”) to first comparator 80, and the output of register 72, representing the current low temperature value, is provided at second input (input “B) to second comparator 82. The output of first comparator 80 serves a load signal 84 to first register 70 (maximum temperature register), and the output of the second comparator 82 serves as a load signal 86 to second register 72 (minimum temperature register).

If the current zone temperature value is greater than the current high temperature value, first comparator 80 outputs load signal 84 having a first logic value (e.g., “1”), which causes the current zone temperature value to be loaded into first register 70 to thereby become the current high temperature value. Similarly, if the current zone temperature value is less than the current low temperature value, second comparator 82 outputs a load signal 86 having a logic high, which cause the current zone temperature value to be loading into second register 72 to thereby become the current low temperature value. If the current zone temperature is neither greater than the current high temperature value nor less than the current low temperature value, the current zone temperature value is loaded into neither first register 70 nor second register 72 so that the current high and low temperature values remain unchanged. Although illustrated as employing two comparators, it is noted that a single comparator may be employed, where such single comparator would be time-multiplexed to first compare the zone temperature to the high temperature value and then to the low temperature value.

In one example, after evaluation of a series of zone temperature values has been completed, the maximum and minimum temperatures values from first and second registers 70 and 72 may be provided to other elements of a fluid ejection system, such as to a system controller (e.g., electronic controller 230 of the fluid ejection system of FIG. 6), which may modify the operation of the fluidic die and/or the fluid ejection system based on such maximum and minimum zone temperature values. The above described process is repeated for each series of zone temperature values received from temperature sensors 54 of each zone 32.

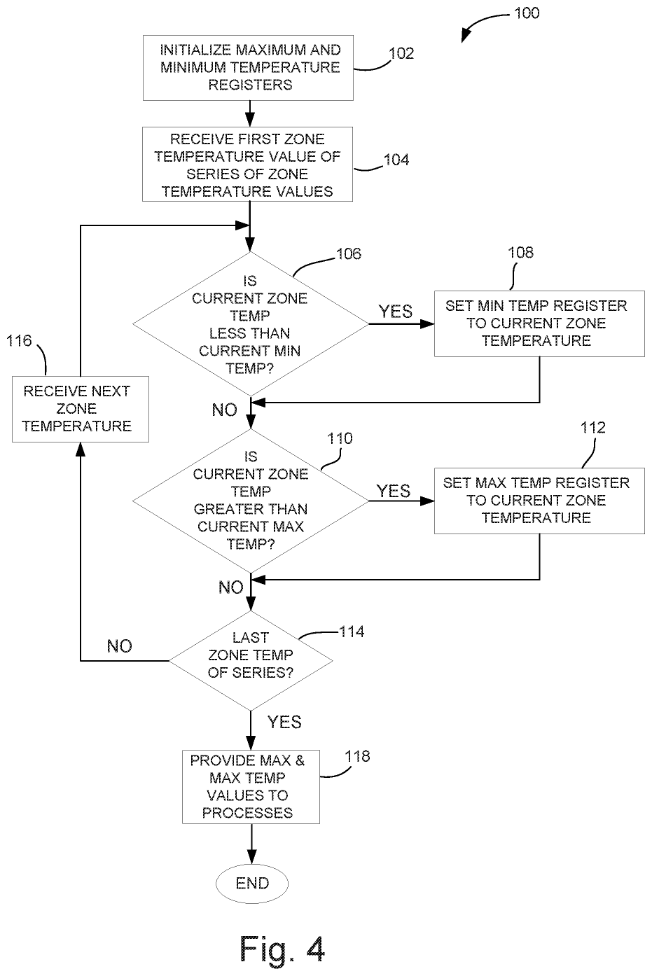

FIG. 4 is a flow diagram generally illustrating a method 100 of monitoring zone temperatures of a fluid die, according to one example. Method 100 begins at 102 with providing initial maximum and minimum temperature values, such as by loading initial maximum and minimum temperature values into maximum and minimum temperature registers 70 and 72, as illustrated by FIG. 3.

At 104, method 100 includes receiving a first zone temperature value of a series of zone temperature values, where each zone temperature value of the series of zone temperature values corresponds to a different zone of the fluidic die. For example, temperature sensor 54-1 to 54-N of zones 32-1 to 32-N provide a series of zone temperature values to temperature monitoring circuit 10, where each zone temperature value corresponds to a different zone 32-1 to 32-N of fluidic die 30. At 106, method 100 queries whether the current zone temperature value is less than the current minimum temperature value, such as stored in minimum temperature register 72. If the answer to the query at 106 is “yes”, method 100 proceeds to 108, where the current minimum temperature is set to the current zone temperature, such as comparator 82 of FIG. 3 outputting a logic high load signal to load the current zone temperature into minimum temperature register 72.

Method 100 then proceeds to 110. If the answer to the query at 106 is “no”, method 100 also proceeds to 110.

At 110, method 100 queries whether the current zone temperature is greater than the current maximum temperature value, such as stored in maximum temperature register 70. If the answer to the query at 110 is “yes”, method 100 proceeds to 112, where the current maximum temperature is set to the current zone temperature, such as comparator 80 of FIG. 3 outputting logic high load signal to load the current zone temperature into maximum temperature register 70.

Method 100 then proceeds to 114. If the answer to the query at 110 is “no”, method 100 also proceeds to 114. At 114, method 100 queries whether the current zone temperature value is the last zone temperature value of the series of zone temperature values. If the answer to the query at 114 is “no”, method 100 proceeds to 116 where the next zone temperature value is received and applied to 106-112 above. If the answer to the query at 114 is “yes”, method 100 is complete for the current series of zone temperature values and will be repeated for each subsequent series of zone temperature values. In one example, it is noted that the maximum and minimum temperature values at 108 and 112, such as stored in registers 70 and 72 in FIG. 3, can be accessed at any time during the evaluation of a series of zone temperature values by other processes, such as by electronic controller 230 of fluidic system 200 of FIG. 6.

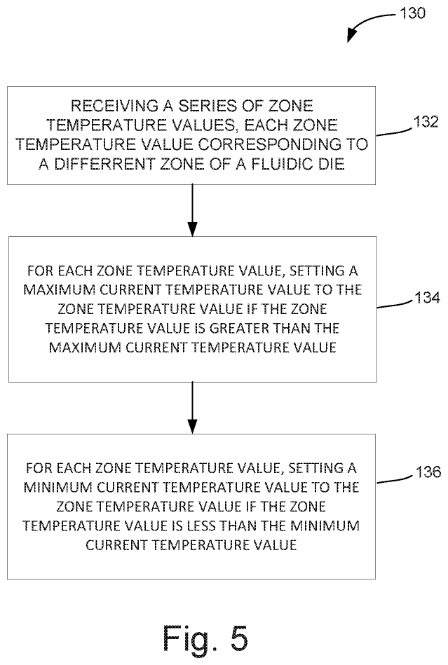

FIG. 5 is a flow diagram generally illustrating a method 130 of monitoring temperatures of a fluidic die, according to one example. At 132, method 130 includes receiving a series of zone temperature values, each zone temperature value corresponding to a different zone of the fluidic die, such as temperature monitoring circuit 10 of FIG. 1 receiving a series of zone temperature values, each corresponding to a different zone 32 of fluidic die 30.

At 134, for each zone temperature value, method 130 includes setting a maximum current temperature value to the zone temperature value if the zone temperature value is greater than the current maximum temperature value, such as evaluation logic 14 of FIG. 2 setting current maximum temperature value 20 to the zone temperature value if the zone temperature value is greater than the current maximum temperature value.

At 136, for each zone temperature value, method 130 includes setting a minimum current temperature value to the zone temperature value if the zone temperature value is less than the minimum current temperature value, such as evaluation logic 14 of FIG. 2 setting current minimum temperature value 18 to the zone temperature value if the zone temperature value is less than the current minimum temperature value.

FIG. 6 is a block diagram illustrating one example of a fluid ejection system 200. Fluid ejection system 200 includes a fluid ejection assembly, such as printhead assembly 204, and a fluid supply assembly, such as ink supply assembly 216. In the illustrated example, fluid ejection system 200 also includes a service station assembly 208, a carriage assembly 222, a print target transport assembly 226, where print media (e.g., paper) is an example of a 2D target, and a bed of build material is an example of a 3D print target. Fluid ejection system 200 further includes an electronic controller 230, where electronic controller 230 may provide the Fire_in signal, as illustrated in FIG. 2, and the minimum and maximum accumulated adjustment values to registers 108 and 110 in FIG. 7. In one example, electronic controller may include all or portions of fire pulse control logic 10 as illustrated by FIGS. 1 and 7, for instance. While the following description provides examples of systems and assemblies for fluid handling with regard to ink, the disclosed systems and assemblies are also applicable to the handling of fluids other than ink.

Printhead assembly 204 includes a printhead 212 which ejects drops of fluid (e.g., ink) through a plurality of orifices or nozzles 214, where printhead 212 may be implemented, in one example, as fluidic die 30. In one example, the drops are directed toward a medium, such as print media 232, so as to print onto print media 232. In one example, print media 232 includes any type of suitable sheet material, such as paper, card stock, transparencies, Mylar, fabric, and the like, suitable for 2D printing, while print media 232 includes media such as a powder bed for 3D printing, or media for bioprinting and/or drug discovery testing, such as a reservoir or container. In one example, nozzles 214 are arranged in a column or array such that properly sequenced ejection of ink from nozzles 214 causes characters, symbols, and/or other graphics or images to be printed upon print media 232 as printhead assembly 204 and print media 232 are moved relative to each other.

Ink supply assembly 216 supplies ink to printhead assembly 204 and includes a reservoir 218 for storing ink. As such, in one example, ink flows from reservoir 218 to printhead assembly 204. In one example, printhead assembly 204 and ink supply assembly 216 are housed together in an inkjet or fluid-jet print cartridge or pen. In another example, ink supply assembly 216 is separate from printhead assembly 204 and supplies ink to printhead assembly 204 through an interface connection 220, such as a supply tube and/or valve.

Carriage assembly 222 positions printhead assembly 204 relative to print media transport assembly 226, and print media transport assembly 226 positions print media 232 relative to printhead assembly 204. Thus, a print zone 234 is defined adjacent to nozzles 214 in an area between printhead assembly 204 and print media 232. In one example, printhead assembly 204 is a scanning type printhead assembly such that carriage assembly 222 moves printhead assembly 204 relative to print media transport assembly 226. In another example, printhead assembly 204 is a non-scanning type printhead assembly such that carriage assembly 222 fixes printhead assembly 204 at a prescribed position relative to print media transport assembly 226.

Service station assembly 208 provides for spitting, wiping, capping, and/or priming of printhead assembly 204 to maintain the functionality of printhead assembly 204 and, more specifically, nozzles 214. For example, service station assembly 208 may include a rubber blade or wiper which is periodically passed over printhead assembly 204 to wipe and clean nozzles 214 of excess ink. In addition, service station assembly 208 may include a cap that covers printhead assembly 204 to protect nozzles 214 from drying out during periods of non-use. In addition, service station assembly 208 may include a spittoon into which printhead assembly 204 ejects ink during spits to ensure that reservoir 218 maintains an appropriate level of pressure and fluidity, and to ensure that nozzles 214 do not clog or weep. Functions of service station assembly 208 may include relative motion between service station assembly 208 and printhead assembly 204.

Electronic controller 230 communicates with printhead assembly 204 through a communication path 206, service station assembly 208 through a communication path 210, carriage assembly 222 through a communication path 224, and print media transport assembly 226 through a communication path 228. In one example, when printhead assembly 204 is mounted in carriage assembly 222, electronic controller 230 and printhead assembly 204 may communicate via carriage assembly 222 through a communication path 202. Electronic controller 230 may also communicate with ink supply assembly 216 such that, in one implementation, a new (or used) ink supply may be detected.

Electronic controller 230 receives data 236 from a host system, such as a computer, and may include memory for temporarily storing data 236. Data 236 may be sent to fluid ejection system 200 along an electronic, infrared, optical or other information transfer path. Data 236 represents, for example, a document and/or file to be printed. As such, data 236 forms a print job for fluid ejection system 200 and includes a number of print job commands and/or command parameters.

In one example, electronic controller 230 provides control of printhead assembly 204 including timing control for ejection of ink drops from nozzles 214. As such, electronic controller 230 defines a pattern of ejected ink drops which form characters, symbols, and/or other graphics or images on print media 232. Timing control and, therefore, the pattern of ejected ink drops, is determined by the print job commands and/or command parameters. In one example, logic and drive circuitry forming a portion of electronic controller 230 is located on printhead assembly 204. In another example, logic and drive circuitry forming a portion of electronic controller 230 is located off printhead assembly 204. In another example, logic and drive circuitry forming a portion of electronic controller 230 is located off printhead assembly 204.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A temperature monitoring circuit for a fluidic die, comprising:
input logic to receive a series of zone temperature values, each zone temperature value corresponding to a different zone of the fluidic die; and
evaluation logic, for each zone temperature value, to:
replace a current minimum temperature value with the zone temperature value if the zone temperature value is less than the current minimum temperature value; and
replace a current maximum temperature value with the zone temperature value if the zone temperature value is greater than the current maximum temperature value.

2. The temperature monitoring circuit of claim 1, prior to receiving the series of zone temperature values, the evaluation logic to:
set the current minimum temperature value to an initial minimum temperature value; and
set the current maximum temperature value to an initial maximum temperature value.

3. The temperature monitoring circuit of claim 2, the initial minimum and maximum temperature values being a midpoint temperature of expected zone temperature values.

4. The temperature monitoring circuit of claim 3, the initial minimum value being a value greater than a designed operating temperature of the fluidic die, and the initial maximum value being a value less than the designed operating temperature.

5. The temperature monitoring circuit of claim 1, including:
a first memory element to store the maximum temperature value; and
a second memory element to store the minimum temperature value.

6. The temperature monitoring circuit of claim 1, the temperature monitoring circuit being disposed on the fluidic die.

7. A fluidic die comprising:
a number of zones, each zone including:
a number of fluidic actuators; and
a temperature sensor to provide a zone temperature value indicating a temperature of the corresponding zone; and
a temperature monitoring circuit to:
receive a series of zone temperature values from the temperature sensor of each zone, each zone temperature value corresponding to a different one of the zones;
replace a current minimum temperature value with the zone temperature value if the zone temperature value is less than the current minimum temperature value; and
replace a current maximum temperature value with the zone temperature value if the zone temperature value is greater than the current maximum temperature value.

8. The fluidic die of claim 7, prior to receiving the series of zone temperature values, the temperature monitoring circuit to:
set the current minimum temperature value to an initial minimum temperature value; and
set the current maximum temperature value to an initial maximum temperature value.

9. The fluidic die of claim 8, the initial minimum and maximum temperature values being a midpoint temperature of expected zone temperature values.

10. The fluidic die of claim 8, the initial minimum value being a value greater than a designed operating temperature of the fluidic die, and the initial maximum value being a value less than the designed operating temperature.

11. The fluidic die of claim 7, including:
a first register to store the maximum temperature value; and
a second register to store the minimum temperature value.

12. A method of monitoring temperatures of a fluidic die, comprising:
receiving a series of zone temperature values, each zone temperature value corresponding to a different zone of the fluidic die;
for each zone temperature value, setting a maximum current temperature value to the zone temperature value if the zone temperature value is greater than the maximum current temperature value; and
for each zone temperature value, setting a minimum current temperature value to the zone temperature value if the zone temperature value is less than the minimum current temperature value.

13. The method of claim 12, including:
setting the maximum current temperature value and the minimum current temperature value to initial values prior to receiving the series of zone temperature values.

14. The method of claim 13, including:
setting the initial values being equal to a midpoint temperature of expected zone temperature values.

15. The method of claim 12, including:
leaving the maximum and minimum zone temperature values unchanged if the current zone temperature value is not greater than the maximum temperature value and not less than the minimum temperature value.
